(19) United States
(12) Patent Application Publication
(10) Pub. No.: US 2005/0128663 A1
(43) Pub. Date: Jun. 16, 2005

(54) Semiconductor device and method of manufacturing the same

(76) Inventors: Soichi Yamazaki, Yokohama-shi (JP); Hiroyuki Kanaya, Yokohama-shi (JP); Kazuhiro Tomioka, Yokohama-shi (JP); Koji Yamakawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/750,814

(22) Filed: Jan. 5, 2004

(30) Foreign Application Priority Data
Sep. 16, 2003 (JP) 2003-323330

(51) Int. Cl. H02H 9/00

(52) U.S. Cl. 361/56

(57) ABSTRACT

There is disclosed a semiconductor device comprising a capacitor comprising a lower electrode provided above a substrate, a capacitor insulating film selectively provided on the lower electrode, and an upper electrode selectively provided above the lower electrode so that the capacitor insulating film can be interposed between the upper and lower electrodes, an electrode protection film formed of oxide conductors containing at least one of metal elements such as Sr, Ti, Ru, Ir and Pt, and provided on the upper electrode, an interlayer insulating film provided on the electrode protection film, an upper layer interconnect wire for the lower electrode provided on the interlayer insulating film, and electrically connected to the lower electrode, and an upper layer interconnect wire for the upper electrode provided on the interlayer insulating film, and electrically connected to the upper electrode.

### CROSS-REFERENCE TO RELATED APPLICATIONS

This application is based upon and claims the benefit of priority from the prior Japanese Patent Application No. 2003-323330, filed Sep. 16, 2003, the entire contents of which are incorporated herein by reference.

### BACKGROUND OF THE INVENTION

1. Field of the Invention

The present invention relates to a technique of improving the electrical performance of capacitors included in semiconductor devices such as DRAMs and FeRAMs. In particular, the present invention relates to a semiconductor device, which has improvement in the structure of the vicinity of the capacitor electrode in a chain FeRAM having capacitor offset structural arrangement.

2. Description of the Related Art

Recently, digital electronic apparatuses handle various informations such as still images and motion pictures (video images); as a result, the information content largely increases. For this reason, the semiconductor memory used for these digital electronic apparatuses requires large capacity more than ever. In recent years, the following Ferroelectric Random Access Memory (FeRAM) has been developed. The FeRAM uses ferroelectric films such as PZT (Pb(Zr_{X}Ti_{1-X})O₃), BIT (Bi₄Ti₃O₁₂) or SBT (SrBi₂Ta₂O₉) as the capacitor insulating film. In brief, the FeRAM, which is a non-volatile memory, uses the foregoing ferroelectric films in place of silicon oxide films used for a DRAM as the capacitor insulating film (capacitance insulating film).

For example, an offset structure is given as the capacitor cell structure of the FeRAM. According to the offset structure, the electrode of capacitor and the active region of transistor are connected. The technique described above has been disclosed in JPN. PAT. APPLN. KOKAI Publications No. 10-256503, 2000-357773 and 2000-349247.

Of some FeRAMs using the ferroelectric materials described above, the FeRAM used so far employs the offset structure. In the offset structure capacitor cell, the capacitor is formed, and thereafter, a plug connected to the capacitor electrode and the like are formed. Thus, the offset structure capacitor cell has the following features. There is no possibility that heat treatment for forming the ferroelectric film used as the capacitor insulating film influences the plug. However, in the offset structure capacitor cell, film reduction or an alloy spike is easy to occur in the upper electrode of the capacitor. If film reduction and an alloy spike occurs in the upper electrode, the following problems easily arise.

First, if film reduction or an alloy spike occurs in the upper electrode, useless film stress is easily given to the capacitor insulating film via the upper electrode. As a result, capacitor characteristic is easy to be reduced. Secondly, if an alloy spike occurs in the upper electrode, the capacitor insulating film is directly exposed to plasma atmosphere in the RIE process. For this reason, the capacitor insulating film is easy to receive damage remarkably reducing the capacitor characteristic. In addition, if an alloy spike occurs in the upper electrode, materials for interconnect wire such as Ti, TiN, TaN, Al w or Cu directly contact with the capacitor insulating film. For this reason, these materials for interconnect wire and the capacitor insulating film easily make reaction; as a result, the capacitor characteristic is easily reduced. Thirdly, when film reduction occurs in the upper electrode even if no alloy spike occurs therein, the capacitor easily receives damage by H₂ generated from resist film due to reactions in the RIE process or removing resist film process. As a result, the capacitor characteristic is easy to be reduced.

As seen from the explanation, when film reduction and an alloy spike occur in the upper electrode, there is a high possibility that the capacitor characteristic is reduced. This is a factor of largely reducing yield and reliability of typical semiconductor devices such as Chain FeRAM.

### BRIEF SUMMARY OF THE INVENTION

According to an aspect of the invention, there is provided a semiconductor device comprising: a capacitor comprising a lower electrode provided above a substrate, a capacitor insulating film selectively provided on the lower electrode, and an upper electrode selectively provided above the lower electrode so that the capacitor insulating film can be interposed between the upper and lower electrodes; an electrode protection film formed of oxide conductors containing at least one of metal elements such as Sr, Ti, Ru, Ir and Pt, and provided to cover the upper surface of the upper electrode; an interlayer insulating film provided above the substrate to cover the capacitor and the electrode protection film; an upper layer interconnect wire for the lower electrode provided on the interlayer insulating film, and electrically connected to the lower electrode via a lower electrode plug provided in the interlayer insulating film; and an upper layer interconnect wire for the upper electrode provided on the interlayer insulating film, and electrically connected to the upper electrode via an upper electrode plug provided in the interlayer insulating film and the electrode protection film.

According to another aspect of the invention, there is provided a method of manufacturing a semiconductor device, comprising: selectively providing a capacitor insulating film on a capacitor lower electrode provided above a substrate, and providing a capacitor upper electrode so that the capacitor insulating film can be interposed between the upper and lower electrodes; providing an electrode protection film formed of oxide conductors containing at least one of metal elements such as Sr, Ti, Ru, Ir and Pt, to cover the upper electrode; providing an interlayer insulating film to cover the capacitor and the electrode protection film; and selectively etching the interlayer insulating film so that a first recess for providing a lower electrode plug and a second recess for providing an upper electrode plug can be formed.

### BRIEF DESCRIPTION OF THE SEVERAL VIEWS OF THE DRAWING

FIG. 1A is a plan view showing a semiconductor device according to one embodiment of the invention;

FIG. 1B is a cross-sectional view showing the semiconductor device;

FIG. 2A and FIG. 2B are cross-sectional views to explain the method of manufacturing the semiconductor device according to one embodiment;

FIG. 3A and FIG. 3B are cross-sectional views to explain the method of manufacturing the semiconductor device according to one embodiment;

FIG. 4 is a cross-sectional views to explain the method of manufacturing the semiconductor device according to one embodiment; and

FIG. 5 is a cross-sectional views to explain a semiconductor deice given as a comparative example with respect to one embodiment.

### DETAILED DESCRIPTION OF THE INVENTION

One embodiment of the present invention will be described below with reference to the accompanying drawings.

Before one embodiment of the present invention is described, the problems of the conventional technique will be explained in detail giving a comparative example with respect to one embodiment.

In general, so-called chain FeRAM has the structure of collectively forming upper layer interconnect wires provided on the upper layer of the capacitor and contact plugs connected to upper or lower electrode thereof. In other words, it is general in the chain FeRAM that the upper layer interconnect wires and contact plugs are formed into so-called dual damascene structure. The offset structure capacitor cell included in the chain FeRAM will be briefly described referring to FIG. 5. FIG. 5 is a cross-sectional views showing an offset structure capacitor cell included in the chain FeRAM given as a comparative example with respect to one embodiment.

In the Chain FeRAM 101 shown in FIG. 5, two gates 104 are formed an active region 102 and a silicon substrate 103 formed with isolation region (not shown). Namely, the surface layer of the silicon substrate 103 is provided with two MOS transistors 105 comprising active region 102, isolation region and gate 104. Each gate 104 is composed of gate oxide film 106, gate electrode 107, gate cap film 108 and gate sidewall film 109. The gate electrode 107 comprises stacked fist and second gate electrodes 107a and 107b. The gate cap film 108 and the gate sidewall film 109 are formed of SiN film.

A first interlayer insulating film 110 is formed on the silicon substrate 103 to cover the active region 102 and each gate 104. A stacked interlayer insulating film 113 is further formed on the first interlayer insulating film 110. The stacked interlayer insulating film 113 comprises stacked second and third interlayer insulating films 111 and 112. Each upper surface of these first to third interlayer insulating films 110 to 112 is planarized. Two capacitors 114 are provided on the third interlayer insulating film 112 so that they can be positioned above two gates 104 (MOS transistors 105).

Each capacitor 114 is composed of a capacitor lower electrode provided on the third interlayer insulating film 112, and two capacitor cells provided on the lower electrode 115. Each capacitor cell 116 comprises a capacitor insulating film 117 and a capacitor upper electrode 118. Each capacitor cell 116 uses the lower electrode 115 as the common lower electrode. In addition, each capacitor 116 is coated with a hard mask 119 functioning as a protection film in processing these electrodes. The hard mask 119 is composed of first and second hard masks 120 and 121. The first hard mask 120 is formed to cover the upper surface of each upper electrode 118. The second hard mask 121 is formed to cover the first hard mask 120 and each capacitor 114. A fourth interlayer insulating film 122 is provided on the second hard mask 121.

Upper layer interconnect wires 123 electrically connected to elements described above are provided above each capacitor 114. The upper layer interconnect wires 123 comprises several interconnect wires, that is, one upper layer interconnect wire for the lower electrode 124 and two upper layer interconnect wires for the upper electrode 125. The upper layer interconnect wire for the lower electrode 124 is electrically connected to the lower electrode 115. The upper layer interconnect wires for the upper electrode 125 are electrically connected to each upper electrode 118. The lower electrode 115 is electrically connected to the upper layer interconnect wires for the lower electrode 124 via a lower electrode contact plug 126. Likewise, each upper electrode 115 is electrically connected to the upper layer interconnect wire for the upper electrode 125 via an upper electrode contact plug 127. The upper layer interconnect wire for the lower electrode and the lower electrode contact plug 124; 126 and the upper layer interconnect wires for the upper electrode and the upper electrode contact plugs 125; 127 are formed in a manner of being integrally buried. Namely, these upper layer interconnect wire for the lower electrode and lower electrode the contact plug 124; 126 and the upper layer interconnect wires for the upper electrode and the upper electrode contact plugs 125; 127 are individually formed into so-called dual damascene structure.

Incidentally, there exist contact plugs connected to the active region 102 on the silicon substrate 103 via the upper layer interconnect wire for the lower electrode 124 from the capacitor lower electrode 115. However, these contact plugs do not appear in the cross section shown in FIG. 5; therefore, the illustration is omitted in FIG. 5.

In the chain FeRAM 101 having the offset structure shown in FIG. 5, the lower electrode contact plug 126 electrically connected to the lower electrode 115 is longer than each upper electrode contact plug 127 electrically connected to each upper electrode 118. Here, the process of concurrently forming lower and upper electrode contact holes (not shown) used for forming contact plugs 126 and 127 by RIE is employed. In this case, if etching is carried out until the lower electrode contact hole reaches the lower electrode 115, each upper electrode contact hole is formed deeper than proper depth. In other words, the amount of the etching of each upper electrode contact hole is more than proper rate; for this reason, etching to each upper electrode 118 advances earlier. As a result, film reduction and an alloy spike occur in each upper electrode 118 as seen from FIG. 5.

According to the experiment conducted by the inventors, the following matters can be seen from general Chain FeRAM 101 shown in FIG. 5. If the etching rate by RIE of the first hard mask 120 to the second hard mask 121 exceeds 25%, it can be seen that an alloy spike approximately securely occurs in each upper electrode 118. When film reduction and an alloy spike occur in each upper electrode 118, the following problems easily arise.

First, Al used as material of interconnect wire is formed in each upper electrode contact hole according to reflow process. In this case, if film reduction and an alloy spike exist in each upper electrode 118, unnecessary film stress is easily given to each capacitor insulating film 117 via each upper electrode 118. Thus, the characteristic of each capacitor 114 is readily reduced.

Secondary, if an alloy spike occurs in each upper electrode 118, each capacitor insulating film 117 is directly exposed to plasma atmosphere in RIE process. As a result, each capacitor insulating film 117 is easy to receive damages largely reducing the characteristic of each capacitor 114. If an alloy spike occurs in each upper electrode 118, materials of interconnect wire such as Ti, TiN, TaN, Al, W or Cu provided in each upper electrode contact hole directly contact with each capacitor insulating film 117. As a result, these materials of interconnect wire and each capacitor insulating film 117 readily make reaction; for this reason, the characteristic of each capacitor 114 is readily reduced.

Thirdly, when film reduction occurs in each upper electrode even though no alloy spike occur therein, each capacitor 114 is easy to receive damages due to H₂ generated by reaction of resist (not shown) during RIE process. Thus, the characteristic of each capacitor 114 is readily reduced.

If film reduction or an alloy spike occurs in each upper electrode 118, there is high possibility that the capacitor characteristic is reduced. This is a factor of largely reducing yield and reliability of the Chain FeRAM 101 shown in FIG. 5.

One embodiment of the present invention has been made in order to solve the problems described above. An object of the invention is to provide a semiconductor device, which prevents film reduction or an alloy spike in an upper electrode, and includes a capacitor having the structure capable of improving quality, electrical performance and reliability. Another object of the invention is to provide a method of readily manufacturing the semiconductor device. The present invention will be described below in detail.

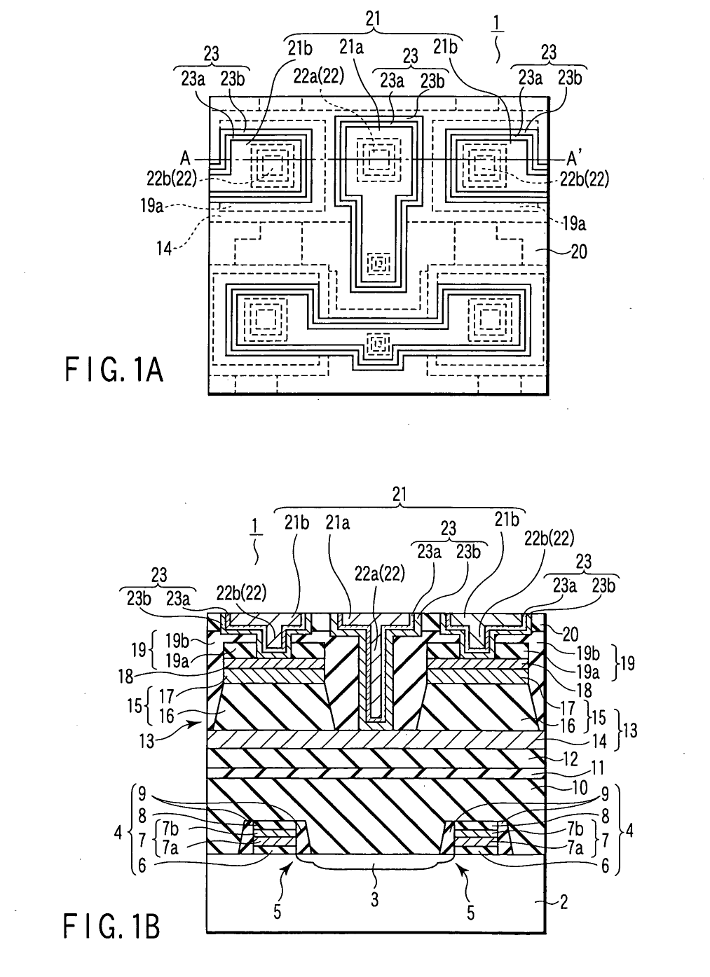

The semiconductor device according to one embodiment of the present invention will be explained with reference to FIG. 1A and FIG. 1B. FIG. 1A and FIG. 1B are plan and cross-sectional views showing the semiconductor device of the embodiment, respectively. More specifically, FIG. 1A is a plan view showing the structure of the vicinity of offset structure capacitor cell (memory cell) included in a so-called Chain FeRAM. FIG. 1B is a cross-sectional view taken along a broken line A-A′ of FIG. 1A.

As shown in FIG. 1B, chain FeRAM 1 includes a p-type silicon substrate 2. The surface layer of the substrate 2 is formed with an active region 3 functioning as source/drain diffusion layer (n-diffusion layer) and a shallow trench isolation (STI) region (not shown). A gate 4 is provided on both sides of the active region 3 one by one. Therefore, the surface layer of the p-type silicon substrate 2 is provided with two MOS transistors 5 comprising source/drain diffusion layer 3 and two gates 4. Each gate 4 is composed of gate insulating film 6, gate electrode 7 functioning as word line, gate cap film 8 and gate sidewall film 9. The gate insulating film 6 is formed of silicon oxide film such as SiO₂ film. The gate electrode 7 has the polycide structure in which WSi_{X} film (WSi₂ film) 7b is stacked on poly-Si film 7a. The gate cap film 8 and the gate sidewall film 9 are formed of silicon nitride film such as SiN film.

A first interlayer insulating film, that is, CVD oxide film 10 is formed on the surface of the p-type silicon substrate 2 to cover source/drain diffusion layer 3 and each gate 4. Further, second interlayer insulating film, that is, CVD oxide film 11 and third interlayer insulating film, that is, silicon oxide film 12 are continuously stacked on the surface of the CVD oxide film 10. The surface of the silicon oxide film 12 is provided with two capacitors (capacitance element) 13 so that they can be positioned above two gates 4 (MOS transistor 5).

The capacitor 13 comprises a capacitor lower electrode 14 provided to cover the upper surface of the silicon oxide film 12, and two capacitor cells 15 selectively provided on the upper surface of the lower electrode 14. The capacitor cell 15 is composed of a capacitor insulating film (capacitance insulating film) 16, and a capacitor upper electrode 17. The upper electrode 17 is provided via the capacitor insulating film 16 interposed between lower and upper electrodes 14 and 17. Each capacitor cell 15 uses the lower electrode 14 as common lower electrode.

The lower electrode 14 is formed of SrRuO₃ film (SRO film), Ir film, IrO₂ film, Pt film, Ti film, TiN film, Ru film RuO₂ film, etc. In addition, the lower electrode 14 may be formed of stacked films combining some of films given above. SRO/Ti/Pt/Ti stacked film, SRO/Ti/IrO₂/Ir/Ti stacked film or SRO/Ti/Ir/Ti stacked film are given as the typical stacked film. In the configuration of these stacked films, the stacked substance is given successively from upper to lower. In the embodiment, the lower electrode 14 is formed using the SRO/Ti/Pt/Ti stacked film.

The capacitor insulating film 16 is formed of ferroelectric films (ferroelectric thin films) such as Pb(Zr_{X}Ti_{1-X})O₃ film (PZT film), Bi₄Ti₃O₁₂ film (BIT film) or SrBi₂Ta₂O₉ film (SBT film). In the embodiment, the capacitor insulating film 16 is formed using the PZT film.

The upper electrode 17 is formed of the same material (film) as the lower electrode 14. Pt/SRO stacked film, IrO₂/Ir/SRO stacked film or Ir/SRO stacked film are given as the typical stacked film of materials forming the upper electrode 17. Likewise, in the configuration of these stacked films, the stacked substance is given successively from upper to lower. In the embodiment, the upper electrode 17 is formed using the Pt/SRO stacked film.

The capacitor 13 is provided with an electrode protection film 18, which is formed of materials having conductivity to cover the upper surface of the upper electrode 17. The electrode protection film 18 is formed of materials hard to be processed as compared with an interlayer insulating film (fourth interlayer insulating film) as a mask film 19 described later. The interlayer insulating film 19 is provided to cover the capacitor cell 15 provided with the electrode protection film 18 and the lower electrode 14. The electrode protection film 18 will be described below in detail.

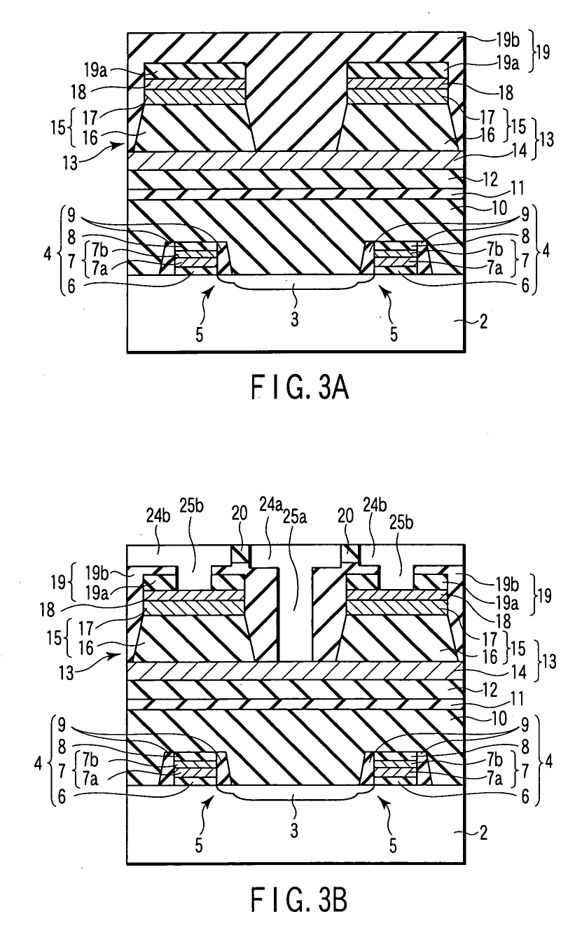

According to the embodiment, the upper electrode 17 of the capacitor 13 is formed at the position higher than the lower electrode 14, as seen from FIG. 1B. Thus, the interlayer insulating film 19 above the upper electrode 17 is thinner than that on the lower electrode 14. In the structure described above, upper and lower electrode contact holes 25b and 25a are concurrently formed at approximately the same rate. As seen from FIG. 3B, these upper and lower electrode contact holes 25b and 25a are formed individually to provide upper and lower electrode contact plugs 22b and 22a electrically connected to upper and lower electrodes 17 and 14. In this case, the contact hole 25b is formed through the interlayer insulating film 19 above the upper electrode 17 thinner than that on the lower electrode 14 so that the upper surface of the electrode protection film 18 can be exposed. On the contrary, the contact hole 25a is formed through the interlayer insulating film 19 on the lower electrode 14 thicker than that above the upper electrode 17 so that the upper surface of the lower electrode 14 can be exposed. Namely, the lower electrode contact hole 25a is formed deeper than the upper electrode contact hole 25b by the height equivalent to capacitor insulating film 16, upper electrode 17 and electrode protection film 18.

As described above, upper and lower electrode contact holes 25b and 25a are concurrently formed at approximately the same rate. In this case, the lower electrode contact holes 25a does not reach approximately the same depth as the upper electrode contact hole 25b. Thus, the upper electrode contact holes 25b penetrates through the interlayer insulating film 19 above the upper electrode 17 so that the upper surface of the electrode protection film 18 can be exposed. However, the lower electrode contact hole 25a does not penetrate through the interlayer insulating film 19 on the lower electrode 14; as a result, the upper surface of the lower electrode 14 is not exposed. Thus, the lower electrode contact holes 25a is further dug down until the upper surface of the lower electrode 14 is exposed. If the electrode protection film 18 is formed of materials easy to be processed in the same degree as the interlayer insulating film 19, the following problem arises. More specifically, with digging down of the lower electrode contact hole 25a, the upper electrode contact hole 25b is further dug down; as a result, it penetrates through the electrode protection film 18. In addition, the upper electrode 17 is scraped by the upper electrode contact hole 25b, and the upper electrode contact hole 25b penetrates through the upper electrode 17. In other words, film reduction or an alloy spike occurs in the upper electrode 17.

As described above, lower and upper electrode contact holes 25a and 25b having mutually different depth are concurrently formed at approximately the same rate. In this case, if the electrode protection film 18 is formed of materials easy to be processed in the same degree as the interlayer insulating film 19, the upper electrode 17 receives damages such as film reduction or an alloy spike. The upper electrode 17 receives damages, and thereby, the characteristic of the capacitor 13 is reduced. This is a factor of reducing the quality and performance of the Chain FeRAM 1 including the capacitor 13; as a result, reliability and yield are reduced. According to the embodiment, the electrode protection film 18 is formed of materials hard to be processed as compared with the interlayer insulating film 19 in order to prevent the upper electrode 17 from receiving damages. Namely, the upper electrode contact hole 25b shallower than the lower electrode contact hole 25a is formed at approximately the same rate as the contact hole 25a until the upper surface of the lower electrode 14 is exposed by the contact hole 25a. The electrode protection film 18 is formed using materials hard to be processed in the same degree as film reduction or an alloy spike does not occur in the upper electrode 17.

More specifically, in the embodiment, the electrode protection film 18 is formed as etching stopper film using materials having an etching rate lower than the interlayer insulating film 19. According to the experiment conducted by the inventors, the electrode protection film 18 was formed using material having processing selectivity of about 25% (¼) or less to the interlayer insulating film 19, and thereby, the following matter was confirmed. More specifically, there is no possibility that film reduction or an alloy spike occurs in the upper electrode 17 in the semiconductor device having the same structure as chain FeRAM shown in FIG. 1. Likewise, the foregoing problem dose not arise in semiconductor devices manufactured with integration level and scale down based on design rule of 30 μm or less, and having improved integration level and scale down. In other words, it was confirmed that film reduction or an alloy spike does not occur in the upper electrode 17 even if the following process is carried out. Namely, the electrode protection film 18 is formed using materials having an etching rate remarkably lower than the interlayer insulating film 19. The contact hole 25b shallower than the contact hole 25a is formed at approximately the same rate as the contact hole 25a until the upper surface of the lower electrode 14 is exposed by the contact hole 25a.

In the specification, the processing selectivity of the electrode protection film 18 to the interlayer insulating film 19 represents processing easiness or hardness of the electrode protection film 18 with respect to the interlayer insulating film 19. Likewise, the processing selectivity of the interlayer insulating film 19 to the electrode protection film 18 represents processing easiness or hardness of the interlayer insulating film 19 with respect to the electrode protection film 18. More specifically, the processing selectivity of the electrode protection film 18 to the interlayer insulating film 19 represents the etching rate of the electrode protection film 18 to the interlayer insulating film 19. Likewise, the processing selectivity of the interlayer insulating film 19 to the electrode protection film 18 represents the etching rate of the interlayer insulating film 19 to the electrode protection film 18.

For example, the interlayer insulating film 19 is formed using only SiO₂ film or stacked film comprising several films including SiO₂ film. In this case, the etching stopper film 18 is formed using SRO film, Ru film, RuO₂ film or IrO₂. Preferably, etching stopper film 18 is formed using SRO film, RuO₂ film and IrO₂, which are oxide conductors, of these materials described above. These films are scarcely etched under the condition of etching SiO₂ film by RIE; therefore, it is substantially impossible to take an etching rate to the SiO₂ film. Namely, the SiO₂ film is a material having substantially an infinite processing selectivity in the RIE process to films employable as the etching stopper 18. In the embodiment, the etching stopper film 18 is formed using SRO film.

The fourth interlayer insulating film as the mask film 19 is provided above the p-type silicon substrate 2. In this case, the mask film 19 is formed to cover each capacitor cell 15 in which the upper surfaces of the lower electrode 14 and each upper electrode 17 coated with the etching stopper film 18. In the embodiment, the mask film 19 is formed as a two-layer structural hard mask comprising first and second hard mask films 19a and 19b. The first hard mask film 19a is provided to cover the upper surface of the etching stopper film 18. The second hard mask film 19b is provided to cover the capacitor cell 15 formed with the first hard mask film 19a and the surface of the lower electrode 14. As described before, the hard mask film 19 is formed using material having an etching rate considerably higher than the etching stopper film 18 in the RIE process. In the embodiment, the first and second hard mask films 19a and 19b are formed using a two-layer structural stacked film stacking SiO₂ film on Al₂O₃ film. A fifth interlayer insulating film, that is, SiO₂ film 20 is provided on the second hard mask film 19b to cover the surface of the mask film 19b.

As illustrated in FIG. 1B, upper layer interconnect wires 21 and plugs 22 are provided in the hard mask film 19 and the fifth interlayer insulating film 20. The upper layer interconnect wires 21 and plugs 22 are electrically connected to lower electrode 14 or upper electrode 17 of the capacitor 13. More specifically, one upper layer interconnect wire for the lower electrode (first interconnect wire) 21a electrically connected to the lower electrode 14 is provided above the region which is not covered with the capacitor insulating film 16 of the lower electrode 14. The upper layer interconnect wire for the lower electrode 21a is electrically connected to the lower electrode 14 via a lower electrode contact plug (first contact plug) 22a. The lower electrode contact plug 22a is integrally formed penetrating through the second hard mask film 19b. Upper layer interconnect wires for the upper electrode (second interconnect wires) 21b electrically connected to the upper electrodes 17 are provided above each capacitor cell 15. Each of the upper layer interconnect wire for the upper electrode 21b is electrically connected to each of the upper electrodes 17 via upper electrode contact plugs (second contact plugs) 22b and the etching stopper film 18. The upper electrode contact plugs 22b is integrally formed penetrating through the first and second hard mask films 19a and 19b.

Thus, the upper layer interconnect wire for the lower electrode 21a and the lower electrode contact plug 22a have so-called dual damascene structure. Likewise, the upper layer interconnect wires for the upper electrode 21b and the upper electrode contact plugs 22b have so-called dual damascene structure. In the embodiment, the upper layer interconnect wires for the lower electrode 21a and the lower electrode contact plug 22a are integrally formed using aluminum (Al). Likewise, the upper layer interconnect wires for the upper electrode 21b and the upper electrode contact plugs 22b are integrally formed using aluminum (Al). A burrier metal film 23 is provided around the upper layer interconnect wires for the lower and upper electrodes 21a, 21b and contact plugs 22a, 22b. In the embodiment, the barrier metal film 23 has two-layer structure comprising ceramic layer having conductivity and metal layer, that is, TiN film 23a and Ti film 23b. The TiN film 23a is provided to directly contact with the upper layer interconnect wires for the lower and upper electrodes 21a, 21b and contact plugs 22a and 22b. The Ti film 23b is provided to directly contact with the lower electrode 14 or etching stopper film 18.

Although illustration is omitted because of disappearing in the cross section shown in FIG. 1B, first to fifth interlayer insulating films 10, 11, 12, 19 and 20 are formed with a contact plug. The contact plug is formed for electrically connecting the lower electrode 14 and the source/drain diffusion layer 3 via the upper layer interconnect wire for the lower electrodes 21a. The contact plug is formed in a manner of forming a contact hole in first to fifth interlayer insulating films 10, 11, 12, 19 and 20, and burying an n⁺ polysilicon film in the contact hole. According to the same process as above, first to fifth interlayer insulating films 10, 11, 12, 19 and 20 are formed with a contact plug, although illustration is omitted. The contact plug is formed for electrically connecting the upper electrode 17 and the source/drain diffusion layer 3 via the upper layer interconnect wires for the upper electrodes 21b.

In FIG. 1B, lower and upper electrodes 14 and 17 comprising stacked layer, and first and second hard mask films 19a, 19b are illustrated as one layer for simplification of drawings.

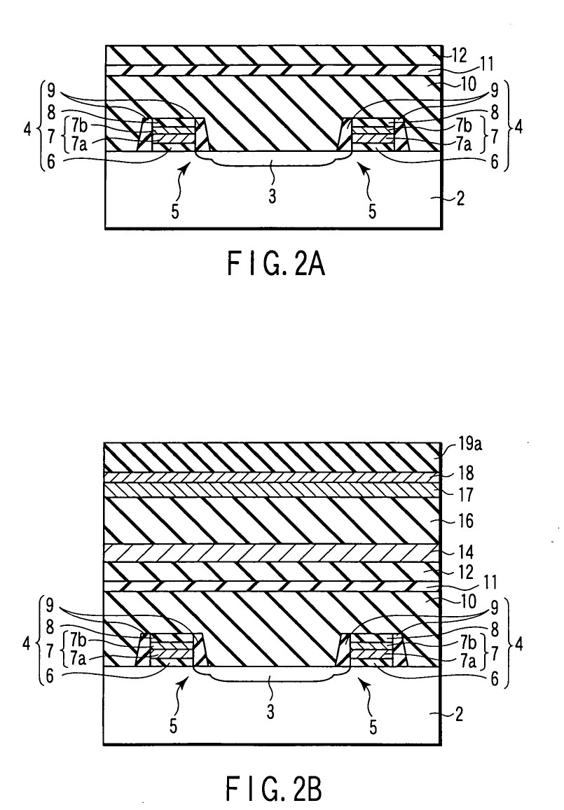

The method of manufacturing the semiconductor device according to one embodiment of the present invention will be described below with reference to FIG. 2A to FIG. 4. FIG. 2A to FIG. 4 are cross-section views to explain the process of manufacturing the semiconductor device according to one embodiment. More specifically, FIG. 2A to FIG. 4 are cross-section views to explain the process of manufacturing the Chain FeRAM 1 described before.

As shown in FIG. 2A, the surface layer of the p-type silicon substrate 2 is formed with two MOS transistors 5 controlling switch operation. The surface layer of the p-type silicon substrate 2, that is, the region other than transistor active region (source/drain diffusion layer) 3 is formed with several trenches (recess) (not shown) for isolation. Each trench is filled with SiO₂, and thereby, the surface layer of the p-type Si substrate 2 is formed with several shallow trench isolation (STI) regions. According to thermal oxidization, the silicon oxide film (SiO₂ film) 6 functioning as gate insulating film is formed on the entire surface of the p-type Si substrate 2 formed with several STI regions to have a thickness of 6 nm. The n⁺ polysilicon film (poly Si film) 7a doped with arsenic (As) is formed on the entire surface of the silicon oxide film 6. The poly Si film 7a is formed as the upper layer portion of the gate electrode 7. WSi₂ film (WSi_{X} film) 7b and silicon nitride film (SiN film) 8 are continuously stacked on the surface of the poly Si film 7a. The WSi₂ film 7b is formed as the lower layer of the gate electrode 7. The SiN film 8 is formed as the gate cap film.

Thereafter, SiO₂ film 6, poly Si film 7a, WSi₂ film 7b and SiN film 8 are processed according to normal photolithography and RIE processes. By doing so, the surface of the p-type Si substrate 2 is formed with two gate electrodes 7, which has polycide structure stacking WSi₂ film 7b on poly Si film 7a. Silicon nitride film (SiN film) 9 is deposited on the surface of the p-type Si substrate 2 formed with gate electrodes 7. Therefore, the SiN film 9 is formed into a predetermined shape according to so-called sidewall leaving process using RIE, and thereby, gate sidewall films (spacer) 9 are provided at both sides of each gate electrode. In this manner, the surface of the p-type Si substrate 2 is formed with two gates 4, which are principal parts of MOS transistors 5. The following process is carried out although the detailed explanation is omitted. Namely, when forming the gate sidewall film 9, the surface layer of the p-type Si substrate 2 is formed with source/drain region (transistor active region) 3 according to normal ion implantation and predetermined heat treatment. By doing so, the surface layer of the p-type Si substrate 2 is formed with two MOS transistors 5 individually comprising source/drain region 3 and two gates 4.

According to CVD process, oxide film (CVD film) 10 having insulation, such as SiO₂ film, is deposited on the entire surface of the p-type Si substrate 2 with two MOS transistors 5 to entirely cover those. Thereafter, the upper surface of the deposited CVD oxide film 10 is planarized according to CMP. The CVD oxide film is formed as the first interlayer insulating film 10.

A contact hole (not shown) communicating with the source/drain region 3 is formed in the first interlayer insulating film 10 according to RIE. Thereafter, thin titanium film (Ti thin film) (not shown) is deposited on the surface of the first interlayer insulating film 10 formed with the contact hole. The Ti thin film is subjected to predetermined heat treatment in predetermined forming gas containing nitrogen. By doing so, the upper layer of the Ti thin film is modified into TiN thin film (not shown). According to CVD, n⁺ polysilicon film (not shown) is deposited on the entire surface of the TiN thin film according until the contact hole is filled with it. Thereafter, CMP is carried out until the surface of the first interlayer insulating film 10 is exposed. By doing so, n⁺ polysilicon film and stacked film comprising TiN and Ti thin films provided outside the contact hole are polished and removed. In other words, the contact hole is filled with n⁺ polysilicon film functioning as contact plug and TiN/Ti stacked film functioning as barrier metal film. In this manner, contact plug (not shown) electrically connected to the source/drain region 3 is formed in the first interlayer insulating film 10.

According to CVD process, nitride film (CVD nitride film) 11 such as SiN film having insulation is deposited on the entire surface of the first interlayer insulating film 10 formed with the contact plug. Thereafter, the upper surface of the deposited CVD nitride film 11 is planarized according to CMP, like the first interlayer insulating film 10. The CVD nitride film is formed as the second interlayer insulating film 11.

Another contact hole (not shown) communicating with another source/drain region (not shown) is formed in first and second interlayer insulating films 10 and 11 according to RIE. Thereafter, the same process as formed the foregoing contact plug is carried out. Namely, the contact hole formed in first and second interlayer insulating films 10 and 11 is filled with n⁺ polysilicon film functioning as contact plug (not shown) and TiN/Ti stacked film functioning as barrier metal film. In this manner, contact plug (not shown) electrically connected to another source/drain region and capacitor 13 is formed in the first and second interlayer insulating films 10 and 11.

According to CVD process, oxide film (CVD oxide film) 12 having insulation, such as SiO₂ film, is deposited on the entire surface of the second interlayer insulating film 11 formed with the contact plug. Thereafter, the upper surface of the deposited CVD oxide film 12 is planarized according to CMP, like the first and second interlayer insulating film 10 and 11. The CVD oxide film is formed as the third interlayer insulating film 12.

As illustrated in FIG. 2B, a film (layer) 14 functioning as the lower electrode of the capacitor 13 is formed on the entire surface of the third interlayer insulating film 12. The following films are successively and continuously stacked on the film 14. One is film (layer) 16 formed as insulating film of the capacitor 13, and another is film (layer) 17 formed as the upper electrode of the capacitor 13. Further, another is film (layer) 18 formed as etching stopper film, and another is film (layer) 19a formed as the first hard mask film.

As depicted in FIG. 3A, films 14, 16, 17, 18 and 19a formed above the third interlayer insulating film 12 is processed so that the capacitor 13 can be formed above each of two MOS transistors 5 one by one.

The process of forming the capacitor 13 will be described below in detail. In this case, the capacitor lower electrode 14 is formed of SRO/Ti/Pt/Ti stacked film, and the capacitor insulating film 16 is formed of PZT film. Further, the capacitor upper electrode 17 is formed of Pt/SRO stacked film, the etching stopper film is formed of SRO film, and the upper electrode processing hard mask film 19a is SiO₂/Al₂O₃ stacked film. In FIG. 2A to FIG. 4, lower and upper electrodes 14, 17 and upper electrode processing hard mask film 19a comprising stacked layer are illustrated as one layer film for simplification of drawings. In FIG. 2A to FIG. 4, the lower electrode processing hard mask film 19b comprising SiO₂/Al₂O₃ stacked film is illustrated as one layer film for simplification of drawings, like the upper electrode processing hard mask film 19a.

Ti film is deposited on the surface of the SiO₂ film formed as the third interlayer insulating film by sputtering to have a thickness of about 2.5 nm. Pt film is deposited on the Ti film by sputtering to have a thickness of about 100 nm without exposing the Ti film on the atmosphere. Ti film and SRO film are continuously deposited on the Pt film by sputtering. Thereafter, the stacked film comprising Ti, Pt, Ti and SRO films is subjected to rapid thermal anneal (RTA) at the temperature of 650° C. for 30 seconds under O₂ atmosphere. By doing so, SRO/Ti/Pt/Ti stacked film formed as the capacitor lower electrode 14 is obtained.

The PZT film 16 is deposited on the surface of the SRO film by sputtering to have a thickness of about 80 to 140 nm. Thereafter, in order to crystallize the PZT film 16, RTA of about 650° C. is carried out with respect to the PZT film 16 for 30 seconds in O₂ atmosphere. By doing so, the PZT film 16 functioning as capacitor insulating film is obtained.

The SRO film is deposited on the surface of the PZT film 16 by sputtering to have a thickness of about 10 nm. Thereafter, in order to crystallize the PZT film 16, RTA of about 650° C. is carried out with respect to the SRO film for 30 seconds in O₂ atmosphere. In addition, Pt film is deposited on the surface of the SRO film by sputtering to have a thickness of about 50 to 100 nm. By doing so, Pt/SRO stacked film functioning as the capacitor upper electrode 17 is obtained.

The SRO film 18 functioning as etching stopper film is deposited on the surface of the Pt film by sputtering.

The Al₂O₃ film is deposited on the surface of the SRO film 18 by sputtering. The SiO₂ film is deposited on the Al₂O₃ film by CVD. By doing so, SiO₂/Al₂O₃ stacked film functioning upper electrode processing hard mask film (first hard mask) 19a is obtained. The SiO₂/Al₂O₃ stacked film functions as RIE hard mask film when RIE is carried out with respect to the upper electrode 17 of each capacitor 13.

The processes described so far are carried out, and thereby, the structure shown in FIG. 2B is obtained.

The surface of the upper electrode processing hard mask film (SiO₂/Al₂O₃ stacked film) 19a is provided with a resist mask (not shown). Thereafter, the resist mask is processed into a predetermined shape by photolithography and RIE processes. The upper electrode processing hard mask film 19a is process into a predetermined shape by RIE. Thereafter, ashing is carried out so that the resist mask can be removed. Etching stopper film (SRO film) 18, capacitor upper electrode 17 (Pt/SRO stacked film) and capacitor insulating film (PZT film) 16 are successively processed into a predetermined shape by RIE using the upper electrode processing hard mask film 19a as a mask.

As shown in FIG. 3A, the lower electrode processing hard mask film (second hard mask) 19b, that is, SiO₂/Al₂O₃ stacked film is provided on the surface of the capacitor lower electrode (SRO/Ti/Pt/Ti stacked film) to cover two capacitors 13. The SiO₂/Al₂O₃ stacked film 19b is formed in the same manner as the upper electrode processing hard mask film (second hard mask) 19b, that is, SiO₂/Al₂O₃ stacked film 19a. Namely, Al₂O₃ and SiO₂ are successively and continuously deposited on the surface of the capacitor lower electrode 14 according to CVD or sputtering. The SiO₂/Al₂O₃ stacked film 19b functions as RIE hard mask film when RIE is carried out with respect to the lower electrode 14 of each capacitor 13.

The surface of the lower electrode processing hard mask film (SiO₂/Al₂O₃ stacked film) 19b is provided with a resist mask (not shown). Thereafter, the resist mask is processed into a predetermined shape by photolithography and RIE. The lower electrode processing hard mask film 19b is process into a predetermined shape by RIE. Thereafter, ashing is carried out so that the resist mask can be removed. The capacitor lower electrode 14 is processed into a predetermined shape by RIE using the lower electrode processing hard mask film 19b as a mask.

The processes described so far are carried out, and thereby, desired capacitor 13 is formed above each of two MOS transistors 5.

As illustrated in FIG. 3B, the fourth interlayer insulating film, that is, SiO₂ film 20 is deposited on the surface of the lower electrode processing hard mask film 19b by CVD. The surface of the fourth interlayer insulating film (SiO₂ film) 20 is provided with a resist mask (not shown). Thereafter, the resist mask is processed into a predetermined shape by photolithography and RIE. The following, a first recess for an interconnect wire 24a and a first recess for a contact plug 25a are formed in the fourth interlayer insulating film 20 and the lower electrode processing hard mask film 19b by photolithography and RIE. The first recess for an interconnect wire 24a is used for providing the upper layer interconnect wire for the lower electrode (the first interconnect wire) 21a. The first recess for a contact plug 25a is used for providing the contact plug for the lower electrode (the first contact plug) 22a. Likewise, the following, a second recesses for an interconnect wire 24b and a second recesses for a contact plug 25a are formed in the fourth interlayer insulating film 20 and the upper and lower electrode processing hard mask films 19a and 19b by photolithography and RIE. The second recesses for an interconnect wire 24b are used for providing the upper layer interconnect wire for the upper electrode (the second interconnect wire) 21b. The second recesses for a contact plug 25b are used for providing the contact plugs for the upper electrode (the second contact plug) 22b.

In the embodiment, the second recesses for an interconnect wire 24b are formed concurrently with the first recess for an interconnect wire 24a. Simultaneously, the second recesses for a contact plug (second contact hole, upper electrode contact hole) 25b are formed concurrently with the first recess for a contact plug (first contact hole, lower electrode contact hole) 25a. In this case, the lower electrode contact hole 25a is formed integrally with the first recess for an interconnect wire 24a. Likewise, the upper electrode contact holes 25b are formed integrally with the second recesses for an interconnect wire 24b. Thereafter, ashing is carried out so that the resist mask can be removed.

Ti film 23b and TiN film 23a functioning as barrier metal film 23 are successively deposited on each surface of the fourth interlayer insulating film 20 and the lower electrode processing hard mask film 19b by sputtering. These films 20 and 19b are formed with first and second interconnect wire recesses 24a, 24b and first and second contact holes 25a, 25b, respectively, as described above. According to sputtering, Al film is deposited on the surface of the TiN film 23a until first and second interconnect wire recesses 24a, 24b and first and second contact holes 25a, 25b are filled with the Al film. The Al film is materials for forming upper layer interconnect wires for the lower and upper electrode 21a and 21b, lower and upper electrode contact plugs 22a and 22b. Thereafter, the upper surface of the fourth interlayer insulating film 20 is planarized. By doing so, Al/TiN/Ti stacked film is buried in first and second interconnect wire recesses 24a, 24b and first and second contact holes 25a, 25b. In this manner, it is possible to obtain the upper layer interconnect wire for the lower electrode 21a and the lower electrode contact plug 22a, and the upper layer interconnect wires for the upper electrodes 21b and the lower electrode contact plugs 22b, which have dual damascene structure.

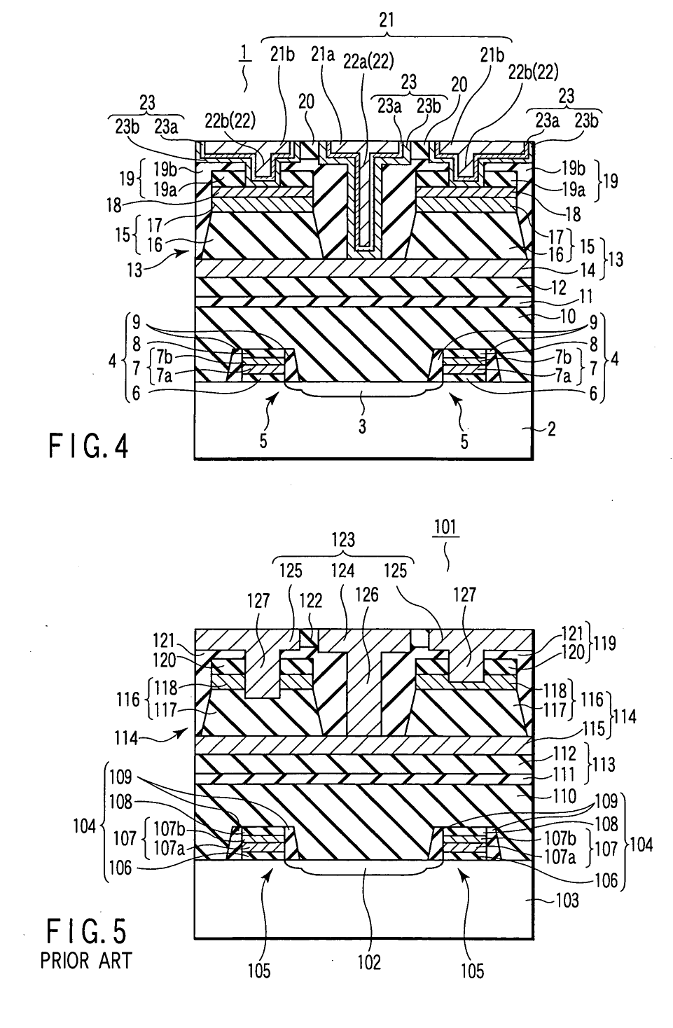

The processes described above are carried out, and thereby, main parts of the chain FeRAM 1 including offset structure stacked type capacitor 13 is formed as seen from FIG. 4. Thereafter, desired Chain FeRAM 1 is obtained via predetermined process although the illustration and explanation are omitted.

According to one embodiment, the etching stopper film 18 formed of the material having the etching rate lower than the hard mask film 19 is interposed between the upper electrode 17 of the capacitor 13 and the hard mask film 19 covering the capacitor 13. Therefore, the following effects are obtained even if upper and lower electrode contact holes 25b and 25a are concurrently formed until the upper surface of the capacitor lower electrode 14 is exposed by the lower electrode contact hole 25a. Namely, there is no possibility that the upper electrode contact hole 25b penetrates through the etching stopper film 18, and intrudes into the capacitor upper electrode 17 or penetrates through there. In other words, the semiconductor device according to the embodiment, that is, chain FeRAM 1 includes offset structure stacked type capacitor 13, which can prevent film reduction or an alloy spike occurring in the capacitor upper electrode 17. Therefore, the chain FeRAM 1 has improved quality, electrical characteristic and reliability, as well as stacked type capacitor 13.

Recently, high integration level and scale down have been advanced in order to achieve the large capacity of semiconductor memory. Simultaneously, ferroelectric memory (FeRAM: ferroelectric Random Access Memory) has been developed, which uses ferroelectric films such as PZT (Pb(Zr_{X}Ti_{1-X})O₃), BIT (Bi₄Ti₃O₁₂) or SBT (SrBi₂Ta₂O₉) as capacitor insulating film. To be brief, the FeRAM, which is a non-volatile memory, uses the foregoing ferroelectric films in place of silicon oxide films used for DRAM as the capacitor insulating film (capacitance insulating film). The FeRAM has the following features, and is expected as next generation memory.

Write and erase are carried out at high speed, and cell is made into small size, and thereby, it is possible to provide write time of 100 nsec. or less equivalent to DRAM.

The FeRAM is different from SRAM, which is the same non-volatile memory, and does not require power supply.

The FeRAM has a large number of rewritable times. More specifically, the characteristic of ferroelectric materials (PZT, BIT, SBT, etc.) used as the capacitance insulating film is utilized, and thereby, the number of rewritable times of 10¹² or more can be provided.

High density (high integration) is further improved in principle, and the same integration level as DRAM can be obtained.

Internal write voltage is reduced to about 2 V; therefore, low power consumption operation is possible.

Bit rewrite by random access is possible.

As described above, the FeRAM has several features superior to DRAM.

In general, the FeRAM uses thin films comprising ferroelectrics such as PZT (Pb(Zr_{X}Ti_{1-X})O₃), BIT (Bi₄Ti₃O₁₂) or SBT (SrBi₂Ta₂O₉) as capacitor insulating film. The ferroelectrics have crystal structure comprising perovskite structure having oxygen eight-faced polyhedron as the basic structure. Ferroelectric, that is, BST studied as DRAM capacitor material has the same crystal structure as ferroelectrics described above. The ferroelectric films described above differ from conventional Si oxide films, and do not show the features, that is, ferroelectricity or high dielectric constant in an amorphous state. For this reason, it is impossible to use ferroelectric films described above as capacitor insulating film. In order to use these ferroelectric films as the capacitor insulating film, the process for crystallizing the ferroelectric films is required. For example, high-temperature crystallization heat treatment and high-temperature In-situ crystallization are given. According to the crystallization process, the temperature of at least about 400 to 700° C. is required in general. Various processes such as laser ablation, vacuum evaporation, MBE are studied as the method of depositing the ferroelectric films. MOCVD, sputtering or CSD (Chemical Solution Deposition) is given as the used deposition process. Typical ferroelectric materials, that is, PZT and SBT are given as the example, and their features will be described below.

The ferroelectric material has spontaneous polarization, and the direction of the spontaneous polarization is inverted depending on the direction of electric field. The spontaneous polarization of the ferroelectric material has polarization value (residual polarization) in a state that no electric field is applied to the ferroelectric material. The value (direction of polarization) depends on the state prior to when the electric field is zero (0). Therefore, the ferroelectric material can induce plus or minus charge to crystal surface depending on the direction of electric filed applied thereto. Thus, the ferroelectric material makes the correspondence to 0 or 1 of memory element in accordance with the plus or minus state. In the conventional FeRAM, a pair of capacitor and transistor is combined (one transistor/one capacitor: 1T/1C), and thereby, one information unit is formed, like DRAM. However, recently, 2T/2C structure FeRAM is mainly used in order to improve reliability. The ferroelectric material positively used for FeRAM is PZT (Pb(Zr_{X}Ti_{1-X})O₃) and SBT (SrBi₂Ta₂O₉) thin films.

The PZT has the following features. The crystallization temperature is about 600° C. The polarization value is large, and the residual polarization value is about 20 μC/cm². The electric field value when the polarization value becomes zero in the hysteresis curve, that is, coercive electric filed is relatively small; therefore, polarization inversion by low voltage is possible. The Zr/Ti composition ratio is changed, and thereby, it is possible to readily control the following structural and ferroelectric characteristics in addition to crystallization temperature. The structural characteristics are grain size, grain profile and crystal structure. The ferroelectric characteristics are polarization, coercive electric filed, fatigue characteristic and leak current. Based on element allowance in perovskite crystal structure, Pb calling A-site is substituted for elements such as Sr, Ba, Ca and La, and Zr and Ti calling B-site are substituted for elements such as Nb, W, Mg, Co, Fe, Ni and Mn. In accordance with these elements described above, it is possible to largely change crystal structure, structural characteristic and ferroelectric characteristic of the PZT. The above are mainly advantageous points of the PZT.

The study of thinning the PZT has been made earlier on, and many experiments have been made using sputtering or sol-gel method. The PZT is the first used materials as the capacitor insulating film of FeRAM in the ferroelectric materials described above. However, the PZT has the problem that the polarization is reduced (fatigue characteristic occurs) with an increase of the number of write times, while having the foregoing merits. The main factor of the fatigue of the PZT is oxygen vacancy generated in the interface between PZT and PT films if the capacitor electrode is formed of Pt. Volatility and diffusion easiness of Pb are given as one of the reasons of generating the oxygen vacancy. A part of the perovskite crystal structure comprises the Pb; for this reason, it forms dipole with nearly positive ion when the oxygen vacancy is generated. As a result, switching charges are reduced. According to the study made recently, it can be seen that the fatigue characteristic of the PZT is accelerated by electric field. Recently, the operation voltage of FeRAM is made low using the properties described above, and the capacitor electrode material is changed from Pt to oxide conductors such as SRO (SrRuO₃) or IrO_{X}. By doing so, the fatigue characteristic of the PZT is improved.

On the other hand, the SBT is a material, which has been developed to improve the fatigue characteristic of the PZT and to realize the low-voltage drive of the FeRAM using the PZT film. The SBT is one of Bi aurivillius phase, and has the following crystal structure. According to the crystal structure, pseudo perovskite structural layer comprising oxygen eight-faced polyhedron as the source of ferroelectricity is held between Bi₂O₂ layers. According to the structure, the main polarization exists in the face vertical to the c-axis, and there is no c-axis direction polarization. Even if the polarization exists in the c-axis direction, the polarization value is smaller than the polarization value in the face vertical to the c-axis. The SBT shows the polarization depending on the number of oxygen eight-faced polyhedron in pseudo perovskite structure. In the BST, even if volatile element, that is, Bi is lost, oxygen vacancy compensating charges if generated in Bi oxide layer; therefore, there is no direct influence to the pseudo perovskite structure. In addition, the SBT contains no Ti having valence easy to change; therefore, the SBT is superior to the PZT. However, the SBT has crystallization temperature higher than the PZT.

The following matter is given in FeRAM using typical ferroelectric films such as Pb(Zr, Ti)O₃ described above and embedded memory including ferroelectric capacitor using these ferroelectric films as capacitor insulating film. Namely, film reduction or an alloy spike in the upper electrode 17 of the capacitor 13 is very important factor of determining product yield or reliability in semiconductor devices. In addition, hydrogen generated when forming contact holes 25a and 25b by RIE or damages by plasma to upper electrode 17 are very important factor of determining product yield or reliability in semiconductor devices.

In the embodiment, the etching stopper film (electrode protection film) 18 having the etching rate lower than hard mask films 19a and 19b is interposed between first and second hard mask films 19a and 19b covering the capacitor 13 and the upper electrode 17. Therefore, when lower and upper electrode contact holes 25a and 25b are formed by RIE; it is possible to prevent the occurrence of film reduction or an alloy spike in the upper electrode 17. The effect serves to improve product yield or reliability in high integration and micro-fabricated FeRAM or embedded memory, manufactured based on design rule of 0.30 μm or less. In particular, the effect serves to greatly improve product yield or reliability in Chain FeRAM shown in FIG. 1A and FIG. 1B, that is, semiconductor devices having the structure in which the upper electrodes 17 of the capacitor 13 are connected by the upper layer interconnect wires for the upper electrodes 21b. In addition, the following effects are obtained.

When the upper layer interconnect wires for the upper electrodes 21b and upper electrode contact plugs 22b are formed, there is no occurrence of film reduction or an alloy spike in the upper electrode 17 of the capacitor 13. Therefore, it is possible to prevent stress and damages applied to the upper electrode 17. By doing so, the characteristic of the capacitor 13 and product yield can be improved. As a result, it is possible to enhance the reliability of the semiconductor device (chain FeRAM) 1.

In addition, there is no occurrence of film reduction or an alloy spike in the upper electrode 17; therefore, it is possible to improve yield when electrically connecting the upper layer interconnect wires for the upper electrodes 21b (upper electrode contact plugs 22b) to the upper electrode 17. When lower and upper electrode contact holes 25a and 25b are formed by RIE, no damage is given to the capacitor insulating film 16. The reaction of the following materials with the capacitor insulating film 16 is prevented. One of the materials is Al, which is the material for forming the upper layer interconnect wires for the lower and upper electrodes 21a, 21b and the lower and upper electrodes contact plugs 22a, 22b, and another is TiN film 23a and Ti film 23b, which are the material for forming the barrier metal film 23. Therefore, it is possible to prevent the characteristic of the capacitor 13 from being reduced. As a result, the product yield and reliability of the semiconductor device 1 can be improved.

In addition, there is no occurrence of film reduction or an alloy spike in the upper electrode 17; therefore, it is possible to prevent plasma damages given to the capacitor 13 in the RIE process. The etching stopper film 18 comprises conductive oxide such as SRO is provided on the upper electrode 17. By doing so, it is possible to prevent damages to upper electrode 17 by hydrogen generated when forming lower and upper electrode contact holes 25a and 25b by RIE. As a result, it is possible to prevent the characteristic of the capacitor 13 from being reduced, and thus, to improve the manufacture yield and reliability of the capacitor 13.

Oxide conductors such as SRO are used as the etching stopper film (electrode protection film) 18, and the etching stopper film 18 is formed under oxygen atmosphere. By doing so, it is possible to fill oxygen into oxygen vacancy generated in the capacitor insulating film 16. As a result, the reliability of the capacitor 13 can be improved.

The semiconductor device according to the present invention and the method of manufacturing the same are not limited to one embodiment described above. Various modifications may be made with respect of part of the structure and process, or the structure and process may be properly combined in the invention without diverging from the spirit and scope of the invention.

For example, the etching stopper film 18 is not limited to the SRO film. Any other forms may be used so long as the etching stopper film 18 is formed of the material containing at least one of metal elements belonging to II-A group, IV-A group and III group. More specifically, the etching stopper film 18 is formed of the material containing at least one metal element of Sr, Ti, Ru, Ir and Pt. In addition, the etching stopper film 18 may be formed of oxide conductor containing one of metal elements described above. For example, IrO₂, RuO₂ and SrRuO₃ are given as the oxide conductor. Even if the above-mentioned materials are used as the etching stopper film 18, the same effect as the SRO film can be obtained. Preferably, the capacitor upper electrode 17 is formed of the material containing at least one of metal elements for forming the etching stopper film 18. By doing so, it is possible to prevent film reduction or an alloy spike occurring in the upper electrode 17.

In the embodiment, film reduction or an alloy spike by the upper electrode contact hole 25b does not occur in the etching stopper film 18. The present invention is not limited to the embodiment described above. In this case, film reduction or an alloy spike may occur in the etching stopper film 18 so long as film reduction or an alloy spike does not occur in the upper electrode 17. Of course, it is preferable that film reduction or an alloy spike does not occur in the etching stopper film 18.

Lower electrode 14, upper electrodes 17, first and second hard mask film 19a and 19b are not limited to the stacked film. These lower electrode 14, upper electrodes 17, first and second hard mask film 19a and 19b may be formed of proper materials. In addition, these lower electrode 14, upper electrodes 17, first and second hard mask film 19a and 19b may be formed of single material. These lower electrode 14, upper electrodes 17, first and second hard mask film 19a and 19b may be formed into independently single or stacked film.

First and second hard mask films 19a and 19b have no need to be formed of the SiO₂/Al₂O₃ stacked film. Even if TiO₂ film or Ta₂O₅ film is used in place of Al₂O₃ film, the same effect as the Al₂O₃ film is obtained. In addition, first and second hard mask films 19a and 19b have no need to be formed of the same material as described before. First and second hard mask films 19a and 19b may be formed of individually different material. In first and second hard mask films 19a and 19b, at least second hard mask film 19b may be formed of the material processed easier than the etching stopper film 18. The first hard mask film 19a may be formed of the material processed harder than the second hard mask film 19b, like the etching stopper film 18. By doing so, the first hard mask film 19a can be used as electrode protection film. The first hard mask film 19a may be formed of the material easy to be processed in the same degree as at least lower and upper electrode contact holes 25a and 25b are concurrently formed at the same rate.

The etching rate of the etching stopper film 18 to the second hard mask film 19b is not necessarily limited to 25% or less. The etching rate may be set to any other value so long as the upper electrode 17 receives no damage when concurrently forming lower and upper electrode contact holes 25a and 25b at the same rate. Etching stopper film 18, first and second hard mask films 19a and 19b are formed taking the following matter into consideration. Namely, these films may be formed of proper materials so that the upper electrode 17 does not receive damages in accordance with the depth difference between lower and upper electrode contact holes 25a and 25b and the method of forming those. Likewise, etching stopper film 18, first and second hard mask films 19a and 19b are formed having a proper thickness so that the upper electrode 17 does not receive damages.

In place of the Al film, W or Cu film may be used as the material for the upper layer interconnect wire for the lower electrode 21a and the lower electrode contact plug 22a. In this case, W or Cu film is deposited using CVD, plating or coating.

The capacitor structure to which the present invention is applicable is not limited to so-called convex type capacitor 13 shown in FIG. 1B and FIG. 4. The present invention is applicable to capacitors having various structures. In particular, the present invention is effective in stacked type capacitors, like the convex type capacitor 13. For example, so-called cylinder type or pedestal type capacitor is given as the stacked type capacitor. Even if the present invention is applied to the above-mentioned type capacitors, the same effect as the embodiment is obtained. Even if the capacitor is not the stacked type, the present invention is applicable so long as the height is slightly different between upper and lower electrodes of the capacitor. Likewise, the present invention is applied, and thereby, the same effect as described above is obtained. For example, even if the present invention is applied to non-stacked type capacitor, that is, so-called planer structural capacitor, the same effect as the embodiment is obtained.

The semiconductor device to which the present invention is applicable is not limited to the chain FeRAM shown in FIG. 1B and FIG. 4. Even if the present invention is applied to general FeRAM and DRAM or embedded memory, the same effect as the embodiment is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A semiconductor device comprising:
a capacitor comprising a lower electrode provided above a substrate, a capacitor insulating film selectively provided on the lower electrode, and an upper electrode selectively provided above the lower electrode so that the capacitor insulating film can be interposed between the upper and lower electrodes;
an electrode protection film formed of oxide conductors containing at least one of metal elements such as Sr, Ti, Ru, Ir and Pt, and provided to cover the upper surface of the upper electrode;
an interlayer insulating film provided above the substrate to cover the capacitor and the electrode protection film;
an upper layer interconnect wire for the lower electrode provided on the interlayer insulating film, and electrically connected to the lower electrode via a lower electrode plug provided in the interlayer insulating film; and
an upper layer interconnect wire for the upper electrode provided on the interlayer insulating film, and electrically connected to the upper electrode via an upper electrode plug provided in the interlayer insulating film and the electrode protection film.

2. The device according to claim 1, wherein the electrode protection film is formed of a material having an processing rate of 25% or less with respect to the interlayer insulating film.

3. The device according to claim 1, wherein the electrode protection film is an etching stopper film, which is formed of a material having an etching rate lower than the interlayer insulating film.

4. The device according to claim 1, wherein the upper electrode is formed of a material containing at least one of metal elements belonging to II-A, IV-A and VIII groups.

5. The device according to claim 3, wherein the interlayer insulating film is a single film comprising only SiO₂ or stacked film containing SiO₂, and
the electrode protection film is an etching stopper film, which is formed of a material having an etching rate of 25% or less with respect to the SiO₂ film.

6. The device according to claim 4, wherein the upper electrode is formed of oxide conductors containing at least one of metal elements belonging to II-A, IV-A and VIII groups.

7. The device according to claim 4, wherein the upper electrode is formed of a material containing at least one of metal elements such as Sr, Ti, Ru, Ir and Pt.

8. The device according to claim 5, wherein the electrode protection film is formed of any oxide conductors of IrO₂, RuO₂ and SrRuO₃.

9. The device according to claim 8, wherein the upper electrode is formed of a material containing at least one of materials forming the electrode protection film.

10. A method of manufacturing a semiconductor device, comprising:
selectively providing a capacitor insulating film on a capacitor lower electrode provided above a substrate, and providing a capacitor upper electrode so that the capacitor insulating film can be interposed between the upper and lower electrodes;
providing an electrode protection film formed of oxide conductors containing at least one of metal elements such as Sr, Ti, Ru, Ir and Pt, to cover the upper electrode;
providing an interlayer insulating film to cover the capacitor and the electrode protection film; and
selectively etching the interlayer insulating film so that a first recess for providing a lower electrode plug and a second recess for providing an upper electrode plug can be formed.

11. The method according to claim 10, wherein the electrode protection film is formed of a material having an etching rate lower than the interlayer insulating film, and
the first and second recesses are concurrently formed according to RIE.

12. The method according to claim 11, wherein the interlayer insulating film is a single film comprising only SiO₂ or stacked film containing SiO₂, and
the electrode protection film is an etching stopper film, which is formed of a material having an etching rate of 25% or less with respect to the SiO₂ film.

13. The method according to claim 12, wherein the electrode protection film is formed as oxide conductor according to sputtering in oxygen atmosphere.

14. The method according to claim 12, wherein the electrode protection film is formed as oxide conductor according to CVD in oxygen atmosphere.
